(19) United States
(12) Patent Application Publication
(10) Pub. No.: US 2010/0318696 A1
(43) Pub. Date: Dec. 16, 2010

(54) INPUT FOR KEYBOARDS IN DEVICES

(75) Inventor: Jani Krisitian Ruotslainen, Helsinki (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/484,327

(22) Filed: Jun. 15, 2009

(51) Int. Cl. G06F 13/12

(52) U.S. Cl. 710/67

(57) ABSTRACT

A method, apparatus, user interface and computer program product for detecting a character input of at least one word input string to a device. If the device is in an alphabetic character input mode, presenting a corresponding alphabetic character on a display of the device. If the device is not in an alphabetic character input mode, determining a type of the character input. If the type of character input is a numeric character, presenting the numeric character on a display of the device. If the type of the character input is an alphabetic character, presenting the alphabetic character on the display of the device and changing a state of the device to the alphabetic character input mode. Any prior character inputs of the at least one word input string are converted into corresponding alphabetic characters.

### BACKGROUND

1. Field

The aspects of the disclosed embodiments generally relate to keypad input systems, and in particular to an improved method for text input in a mobile device.

2. Brief Description of Related Developments

QWERTY keyboards are becoming common in mobile devices, such as for example, mobile handsets. Due to the nature of mobile handsets, these devices have a priority for numeric input in the idle state. Numeric keys are generally overlaid onto the QWERTY keyboard in order to take advantage of the reduced size of mobile devices. One example of such a keyboard is shown in FIG. 1. The keyboard 100 includes one or more keys 102, which can include for example typewriter keys, system keys, application keys, function keys, numeric keys, cursor control keys, enter keys, and any other suitable keys. The typewriter keys include alphabetic keys, such as key 104. Key 106 is an example of a function key.

Due to the reduced size of the keyboard for a mobile device, the numeric keys can be overlaid on the alphabetic keys. As shown in FIG. 1, the keyboard 100 includes a central area 110 where the numeric keys are overlaid onto the alphabetic keys. For example, as shown in FIG. 1, the key 108 for the letter “R” also corresponds to the number “1”. In the exemplary keyboard of FIG. 1, in one embodiment the control key 112 can be used to switch the device between different character input modes. Due to the nature of mobile devices, numbers, or the numeric input mode, is typically the default key use case. This generally prevents the possibility of having direct text input from the idle state of a mobile device, as the numbers overrule the alphabetic characters. Thus, if a user wishes to use the device to input text, such as for a text message or Internet search, the user has to actively cause the device to enter an input mode for alphabetic characters, by activating the key 112, for example.

As the numeric keys are overlaid on the alphabetic ones, the device may not know whether the user intends to type numbers or alphabetic characters (letters), unless specific modes or function keys are activated. Thus, the user experience can be inferior as compared to true text input devices, as the displayed string of characters remains to be a mixture of numbers and characters. In this case, the character string cannot be efficiently used.

It would be advantageous to be able to allow a device to more easily understand what the user is intending to input and provide for greater opportunities to access a true text editor directly from the idle state of a mobile device without sacrificing the priority for numeric input.

### SUMMARY

The aspects of the disclosed embodiments are directed to at least a method, apparatus, user interface and computer program product. In one embodiment the method includes detecting a character input of at least one word input string to a device. If the device is in an alphabetic character input mode, presenting a corresponding alphabetic character on a display of the device. If the device is not in an alphabetic character input mode, determining a type of the character input. If the type of character input is a numeric character, presenting the numeric character on a display of the device. If the type of the character input is an alphabetic character, presenting the alphabetic character on the display of the device and changing a state of the device to the alphabetic character input mode. Any prior character inputs of the at least one word input string are converted into corresponding alphabetic characters.

### BRIEF DESCRIPTION OF THE DRAWINGS

The foregoing aspects and other features of the embodiments are explained in the following description, taken in connection with the accompanying drawings, wherein:

FIG. 1 shows an exemplary keyboard layout for a mobile device;

FIG. 2 is a block diagram of a system incorporating aspects of the disclosed embodiments;

FIGS. 3A-3D illustrate aspects of exemplary processes including aspects of the disclosed embodiments;

FIG. 4A-4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE EMBODIMENT(s)

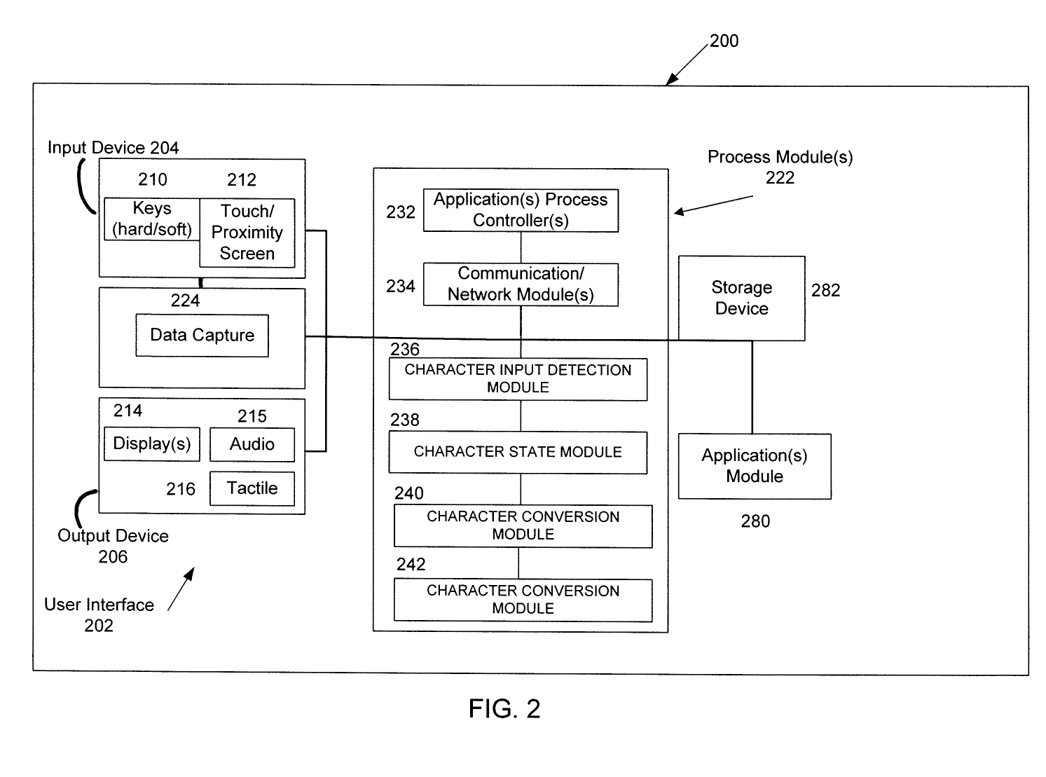

FIG. 2 illustrates one embodiment of a system 200 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide for allowing a user of a device, such as for example a mobile communication device, to transition from an idle state of the device directly to either a numeric character input mode or an alphabetic character input mode, without first having to manually activate either function, by using for example, a control function of the device.

Generally, the system 200 of FIG. 2 includes at least one user interface 206, process modules 222, applications module 280, and storage devices 282. In alternate embodiments, the system 200 can include other suitable systems, devices and components that allow for associating option menus with a title bar and allows for easy and quick identification and selection of the option menus. The components described herein are merely exemplary and are not intended to encompass all components that can be included in the system 200. The devices described with respect to the system 200 also include one or more processors or computer program products to execute the processes, methods, sequences, algorithms and instructions described herein.

The user interface 206 generally comprises one or more input devices 204 and output devices 206. The input device(s) 204 are generally configured to allow a user to input data, instructions, gestures and commands to the system 200. The input device 204 can include devices such as, for example, keys or keypad 210, touch sensitive area or screen 212 and data capture device(s) 224. In one embodiment, the keypad 200 shown in FIG. 2 can comprise the keypad 210 for the system 200. The input device 204 can also be configured to receive input commands remotely or from another device that is not local to the system 200. The data capture device(s) can include camera devices (not shown) or other such other image capturing system(s). In alternate embodiments the input device can comprise any suitable device(s) or means that allows or provides for the input and capture of data, information and/or instructions to a device, as described herein.

The output device(s) 206 are configured to allow information and data to be presented to the user via the user interface 202 of the system 200 and can include one or more devices such as, for example, a display 214, audio device 215 or tactile output device 216. In one embodiment, the output device 206 can be configured to transmit output information to another device, which can be remote from the system 200. While the input device 204 and output device 206 are shown as separate devices, in one embodiment, the input device 204 and output device 206 can be combined into a single device, and be part of and form, the user interface 202. For example, in one embodiment, the touch sensitive screen or area 212 can also provide and display information, such as keypad or keypad elements and/or character outputs in the touch sensitive area of the display 214. While certain devices are shown in FIG. 2, the scope of the disclosed embodiments is not limited by any one or more of these devices, and an exemplary embodiment can include, or exclude, one or more devices.

The process module 222 is generally configured to execute the processes and methods of the disclosed embodiments. As described herein, the process module 222 is generally configured to detect and interpret character inputs and cause the corresponding character to be presented on the display of the device. In one embodiment, the process module 222 includes a character input detection module 236, a character state module 138, a character conversion module 140 and a function detection module 142. In alternate embodiments, the process module 122 can include any suitable function modules for enabling a user to transition directly from an idle state of a device to either a numeric or alphabetic input mode without first having to manually activate the specific mode.

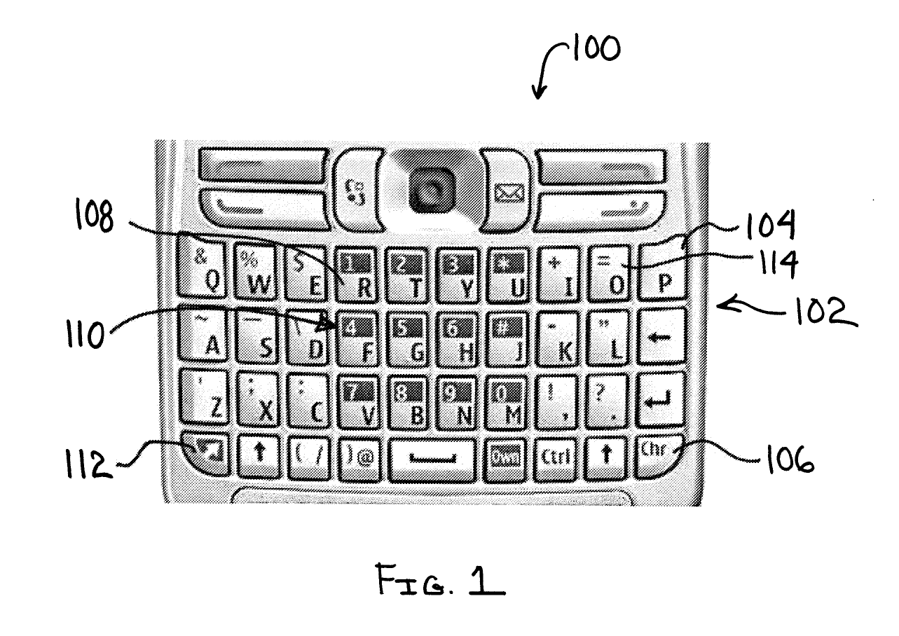

The character input detection module 236 is generally configured to detect and determine whether an inputted character is a numeric or alphabetic character, or some other character. For example, referring to FIG. 1, when key 108 is pressed, the corresponding output can be the letter “R” or the number “1”, depending upon the mode of the device. In an idle state, the device is generally configured to be in a numeric character input mode. Thus, while in this state, the activation or pressing of key 108 will result in the number “1” being presented on the display. However, if the device is not in a numeric character mode, the result could be the letter “R”. When the device is in an alphabetic character input mode, activating the control key 112 and then activating key 108 can result in the number “1” being presented on the display. The character input detection module 236 is configured to determine the mode of the device and the intended character.

The character state module 238 is generally configured to define and set the character input mode of the device. The character input state can manually be set by the user, or in one embodiment, the character input state can automatically be set based on the character input type. For example, in one embodiment, the default character input state while the device is in an idle mode is numeric character input. Thus, when a key is activated, the corresponding numeric character will be presented on the display. If the user inputs an alphabetic character while the device is in the numeric state, in one embodiment, the character state module 238 can receive information regarding the inputted character from the character input detection module 236 and automatically switch or set the state of the device to the alphabetic character input mode.

The character conversion module 240 is generally configured to determine the type of characters in an inputted character string, compare the previously inputted character types to the currently inputted character type, and convert the previously inputted characters to the current character type, if certain conditions are met. For example, in one embodiment, if a user has entered alphabetic characters to form a character string, or a portion thereof, and then inputs a numeric character or such other character indicating that the character string is to be a numeric character string, the character conversion module 240 is configured to convert each character in the character string to the corresponding numeric character. Thus, if the user presses key 108 of FIG. 1 and the device is in the alphabetic mode, the letter “R” is displayed. If a subsequent input to the device indicates that the inputted character(s) should be numeric, the character conversion module 240 will change the letter “R” to the corresponding number “1”. The same processing can occur going from numeric to alphabetic characters.

The character function detection module 242 is generally configured to interpret an inputted character string and determine if the inputted character string corresponds to a function or application of the device. If the inputted character string does correspond to a function or application of the device, the character function detection module 242 is configured to cause the device to present a menu of one or more options related to the identified function or application. For example, it the word “phone” is entered, a menu of “phone” related functions can be presented. If the work is “address” or “contact”, a menu of address book or contact application and/or functions can be presented. In this way, the user does not have to search for the application or functions, but rather they are automatically presented when the word is inputted to the device.

Each of the character input detection module 236, the character state module 238, the character conversion module 240 and character function detection module 242 are configured to receive and transmit information to and between each other and each of the other devices, module and components of the system 200. Each module can include its own processor(s) and computer readable storage medium for carrying out and executing the processes described herein.

The application process controller 232 can be configured to interface with the applications module 280, for example, and execute applications processes with respects to the other modules of the system 200. In one embodiment the applications module 280 is configured to interface with applications that are stored either locally to or remote from the system 100 and/or web-based applications. The applications module 280 can include any one of a variety of applications that may be installed, configured or accessible by the system 200, such as for example, office, business, media players and multimedia applications, web browsers and maps. In alternate embodiments, the applications module 280 can include any suitable application. The communication module 234 shown in FIG. 2 is generally configured to allow the device to receive and send communications and messages, such as text messages, chat messages, multimedia messages, video and email, for example. The communications module 134 is also configured to receive information, data and communications from other devices and systems or networks, such as for example, the Internet. In one embodiment, the communications module 234 is configured to interface with, and establish communications connections with the Internet.

In one embodiment, the applications module 280 can also include a voice recognition system that includes a text-to-speech module that allows the user to receive and input voice commands, prompts and instructions, through a suitable audio input device.

In one embodiment, a predictive text module (not shown) can be provided as a separate module or as a component of one of the modules of the process module 222. The predictive text module is generally converted to provide suggested or alternative text selections based on the inputted textual characters.

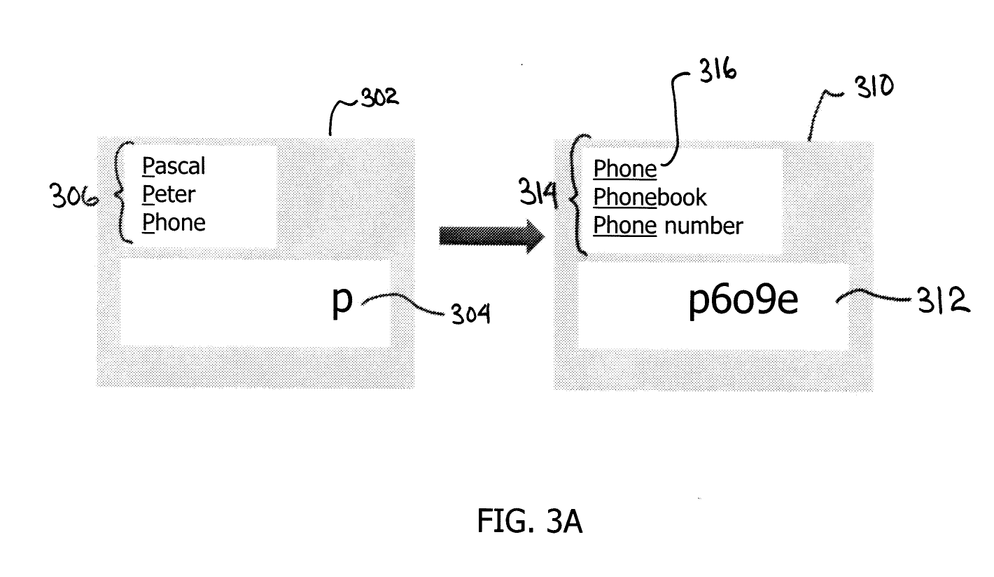

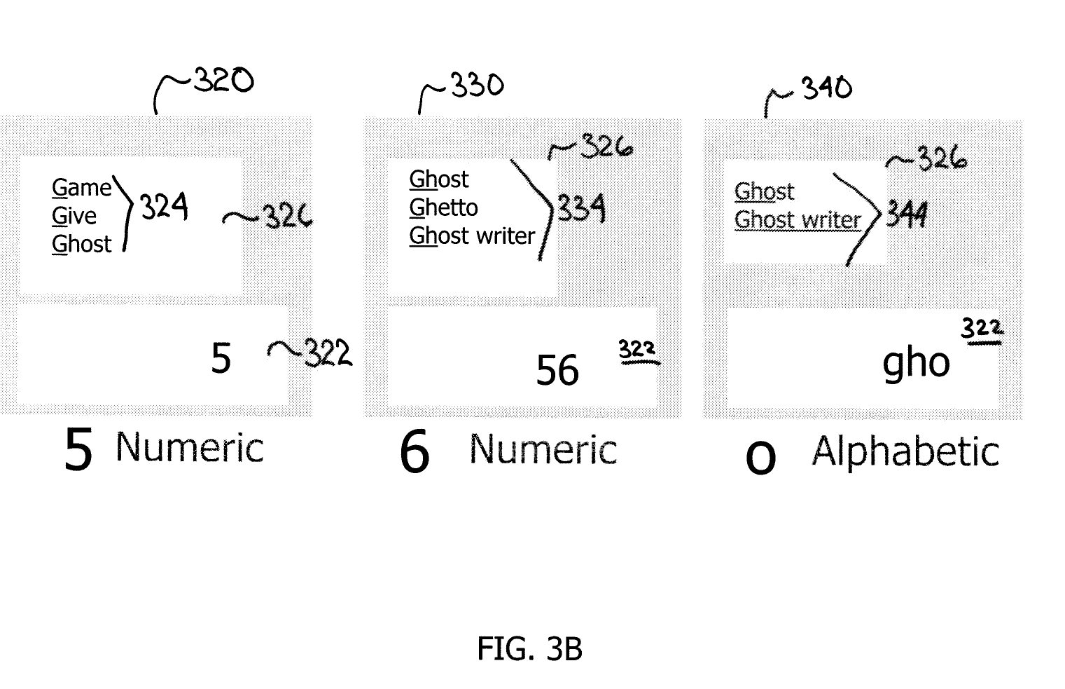

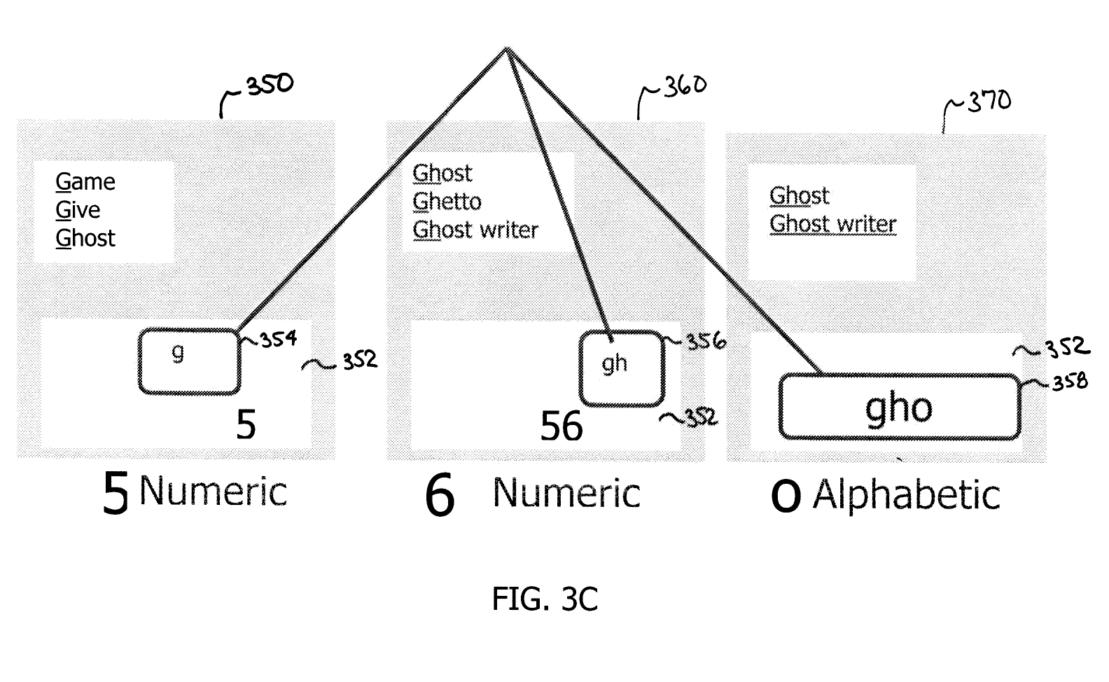

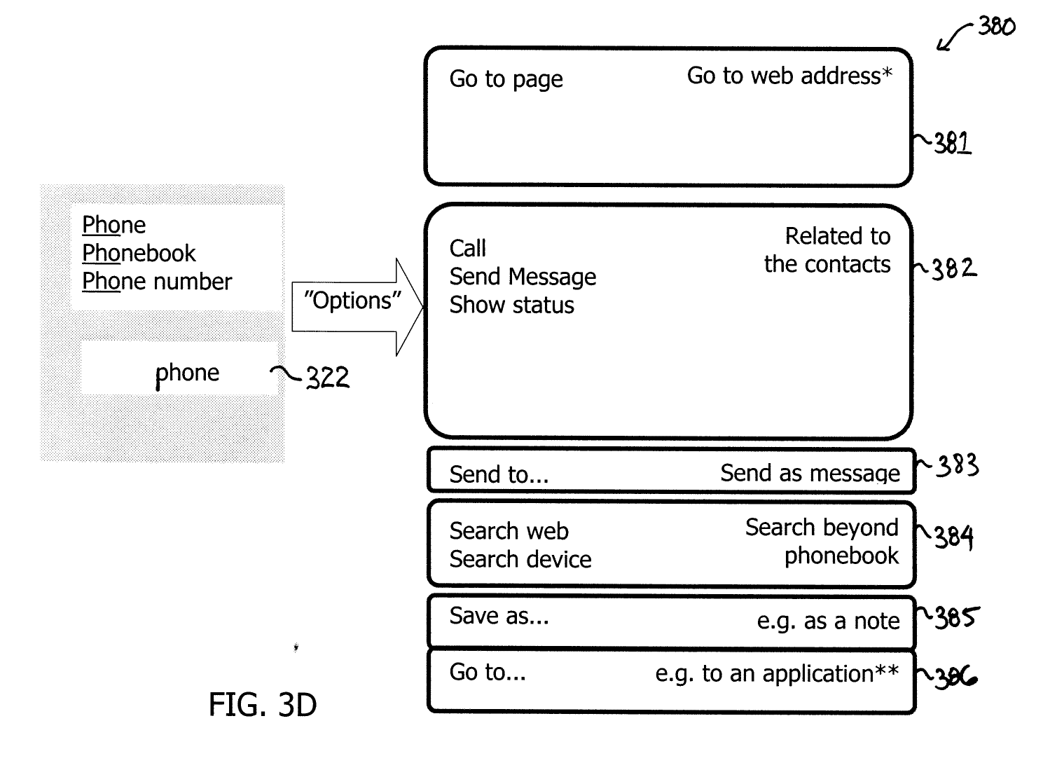

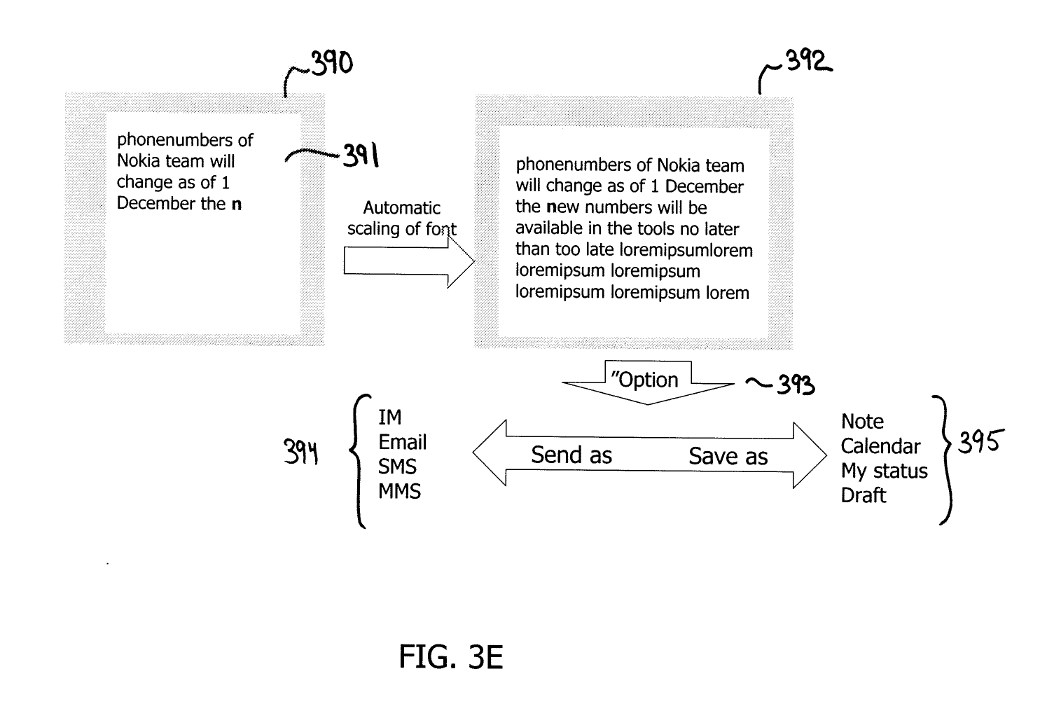

Referring to FIG. 3A-3D, exemplary processes incorporating aspects of the disclosed embodiments will be described. In FIG. 3A, in the first screen 302, the key 104 of FIG. 1 has been activated and the letter “p” is presented on the display of the device. The key 104 is limited to the alphabetic character “p.” In one embodiment, a predictive text function of the device can present a list 306 of possible character strings that begin with the inputted character, in this case “p” can be also be presented as suggestions or alternatives to the inputted character. The user can select one of the word 306 presented, or continue to enter characters.

In screen 310, a character string 312 represented as “p6o9e” has been inputted. The predictive text function recognizes the alphabetic equivalent of each inputted character. Thus, the number “6” corresponds to the letter “h”, while the number “9” corresponds to the letter “n” as shown in FIG. 1. The predictive text function provides a number of alternative words 314 to the character input 312. The work “phone” 316 in the list 314 corresponds to the character input 312. As more characters are inputted, the number of suggested alternatives can be narrowed.

As shown by the keyboard layout of FIG. 1, the keys for the letters R, T, Y, U, F, G, H, J, V, B, N and M have the numbers 1-0 corresponding thereto. Thus, as shown by the example in FIG. 3A, the word “phone” corresponds to the character input of “p6o9e.” The character input “56os2” results in the word “ghost.” However, the word “lapse” is recognized by the activation of the keys “lapse”, without any numeric keys.

The aspects of the disclosed embodiments provide for displaying the intended character result directly from the idle state of the device without having to manually select a numeric or alphabetic character state or function. Referring to FIG. 3B, in screen 320, the user has activated the key of keypad 100 of FIG. 1 corresponding to the letter “G”. Since the device is in a default, numeric character input mode, the number “5” is presented in the input character display area 322. A list 324 of words beginning with the letter “G” is also presented in the word list display area 326. In one embodiment, the display areas 324 and 326 form part of a single display 214. Each display area 324 and 326 can comprises a separate window within a single display, or appear as “pop-ups” in a single display window. In alternate embodiments, the character input area 322 and word list presentment area 326 can be provided by, and/or displayed in any suitable manner. In an embodiment where the device is for the sight impaired, the presentation of information in each of the areas 324 and 326 can be an audible presentation of information, with or without any corresponding visual display.

In screen 330, a second character has been inputted. In this case, activation of the key corresponding to the letter “H” results in the number “6” being presented in the input character display area 322. Since the key for the number “6” corresponds to the letter “h”, the word list 326 of screen 320 is updated and a new word list 334 based on the combination of the letters “g” and “h” is presented in the word list area 326.

In this example, it is the user's intention to input a word from the default state of the device. As noted earlier, in the idle mode of a mobile communication device, the default state for character input is the numeric state. To change from that state in the idle mode, the user would need to manually change the functionality, or mode, of the device. However, in accordance with the aspects of the disclosed embodiments, the user does not need to take such action, but rather, during the course of inputting characters, when the first non-numeric character is inputted, the character input mode of the device will change to alphabetic and each of the preceding inputted characters will be converted to, or changed into its corresponding alphabetic equivalent. Thus, as shown in screen 340 of FIG. 3B, the key 114 corresponding to the character “o” has been activated. Since this key 114 has no numeric equivalent when the state of the device is the numeric character input mode, the alphabetic character “o” will be presented in the input character display area 322. Since this character is non-numeric, the state of the character input mode of the device changes from the numeric mode to the alphabetic mode. Additionally, each of the previously entered characters, in this case the numbers “5” and “6” are converted or changed into their corresponding alphabetic equivalents, or “p” and “h”. Another list 344 of word suggestions or alternatives is presented in the word list display area 326. The list is more narrowed by based on the three inputted characters of “g”, “h” and “o”. The user can select one of the words from the list 344, or continue to enter characters. Any subsequently entered characters will be displayed in the input character display area 322 as letters, as the state of the character input mode of the device has been changed from numeric to letters.

In one embodiment, referring to FIG. 3C, the alternative text can also be displayed when inputting numbers. As shown in screen 350, when the number “5” is inputted and displayed in area 352, the corresponding letter “g” is displayed in area 354. In one embodiment, area 354 can be a subpart of the area 352, or a separate window within the display area. In screen 360, the letters “gh” are shown in area 356 as corresponding to numbers “56”. In screen 370, the letter “o” has been input, and since this is a non-numeric key, the numbers “56” previously in the input character display area 352 are converted to the corresponding letters “gh” to form the character or word sequence “gho” as shown in area 358.

In one embodiment, when a sequence of numeric characters has been inputted, and a corresponding letter equivalent is desired to be displayed, activation of a control key, such as for example key 112 of FIG. 1, can be used to convert the numeric character sequence into the corresponding letter equivalent. This can be advantageous where a character input sequence does not include a non-numeric character or key. In alternate embodiments, any suitable key can be used to covert the character sequence. For example, activation of the space bar during a character input sequence can be used to indicate alphabetic typing rather than numeric based.

In an embodiment where the look and feel of the keyboard can be dynamically changed, such as for example with a touch screen display and/or adaptive keyboard, the numbers can be removed from the keyboard display when the non-numeric or alphabetic character input mode is engaged. Alternatively, the numbers can be removed from the keys when in a non-numeric character entry mode of the device.

Referring to FIG. 3D, in one embodiment, when word are inputted, if the words correspond to a function, command or application of the system 200 shown in FIG. 1, a menu of selection options can be provided that enable changing a state of the device to an active mode. For example, the character string “phone” has been input and is presented in the input character area 322. A menu 380 of one or more options can be presented that allow for directly entering into an application or executing a command. For example, the menu option 381 provides direct integration into a web browser and can assist the user in accessing a web address without having the complete address, such as for example the “www” portion of the web address. The menu items 382-386 provide for accessing other functions. In a basic application, there can be a list of static options, where the options are not dependent upon the inputted word. In more advanced applications, the options can change in accordance with the inputted word. For example, any selection related to utilizing the existing entries in the phone contacts list would not be available if there is no contact corresponding to the inputted word. Similarly, if a string of several words is inputted, the selection options could be filtered or limited. For example, if a string of several words is detected as inputted, a “Go to Page” option for web page uniform resource locators (“URL's”) might be eliminated, as a URL generally will not comprise several, separate words. Instead, the string might automatically be searched by a search engine, with the results automatically displayed to the user, or the user taken to the first, or other designated search result.

In one embodiment, the inputted word can be related to a device of the system 100 of FIG. 1, and access or functions related to the determined device can be presented. For example, if the inputted word is “music”, the menu 380 can present option related to a music application(s) and/or devices, or a multi-media messaging application. If the inputted word is “camera” or “image”, the menu 380 can present menu selection items related to imaging applications and/or devices.

Referring to FIG. 3E, in the situation where the inputted text exceeds the length of any item in the phone book, there will not be any corresponding phonebook results. In one embodiment, the detection of the entry of such text will open a text editing application. For example, as shown in screen 390, the inputted text 391 exceeds a size or length of any phonebook entry. Accordingly, a suitable text editor application is opened, as shown in screen 392. In one embodiment, the font of the inputted text can automatically be scaled to fit within the display area of screen 392. The text can be edited in accordance with the functions of the corresponding editor. Other options 393 can be presented related to the text, which can include for example, sending 394 the text to another application, such as an Instant messaging application, email application, SMS or MMS service. Alternatively, the edited text could be saved to a corresponding or suitable application, such as for example, a Note application, Calendar application, My Status application, or document application. In alternate embodiments, any suitable action can be taken with respect to the edited text.

Other characters, such as numbers, could also be utilized in the application of the disclosed embodiments. Similarly to text based input, mathematical signs and functions could imply calculations. For example, if the user inputs “2+2”, the next option presented could be “calculate”. Alternatively, if the “=” function is inputted, the result could automatically be outputted. This avoids the need to open a separate calculator function while in a text or other character input mode.

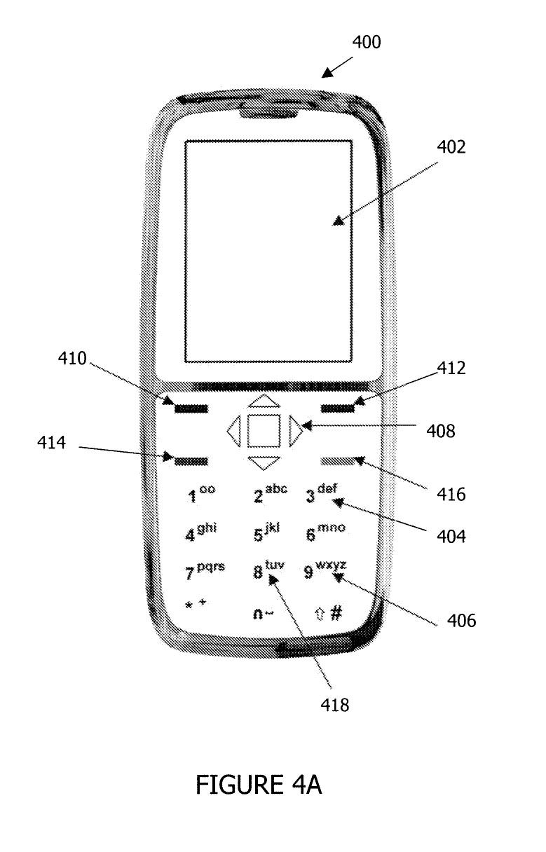

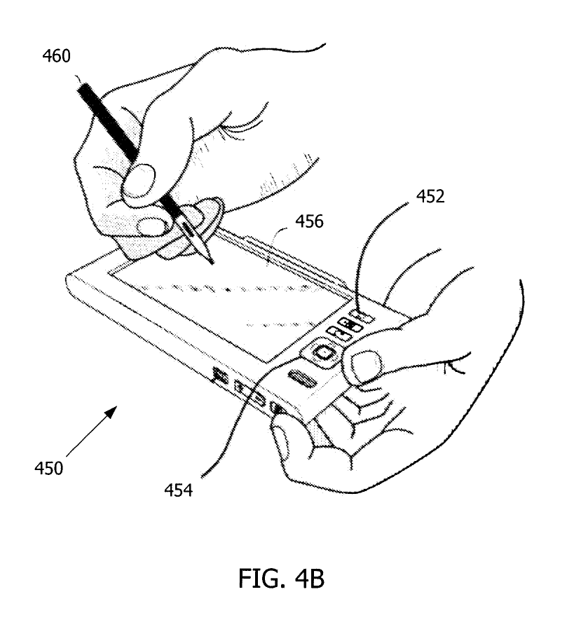

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 has a display area 402 and a touch sensitive area 404. The user interface of the disclosed embodiments can be implemented on or in a device that includes a touch sensitive area, touch screen display, proximity screen device or other graphical user interface.

In one embodiment, the touch sensitive area 404 can include keypad 406 as an input device. The keypad 406, in the form of soft keys, may include any suitable user input functions such as, for example, a multi-function/scroll key 410, soft keys 410, 412, call key 414, end key 416 and alphanumeric keys 418. The keypad 406 can also be in the form of the keypad 100 shown in FIG. 1. In one embodiment, referring to FIG. 4C, the touch screen area 484 of device 480 can also present secondary functions, other than a keypad, using changing graphics.

In one embodiment, the display 402 is integral to the device 400. In alternate embodiments the display may be a peripheral display connected or coupled to the device 400. As shown in FIG. 4B, in one embodiment, a pointing device, such as for example, a stylus 460, pen or simply the user's finger may be used with the display 456. In alternate embodiments any suitable pointing device may be used. In other alternate embodiments, the display may be any suitable display, such as for example a flat display 456 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, the device 400 can include an image capture device such as a camera (not shown) as a further input device. The device 400 may also include other suitable features such as, for example a loud speaker, tactile feedback devices or connectivity port. The mobile communications device may have a processor or other suitable computer program product (not shown) connected or coupled to the display for processing user inputs and displaying information on the display 402 and touch sensitive area 404. A computer readable storage device, such as a memory (not shown) may be connected to the processor for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 200 of FIG. 2 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In one embodiment, the touch screen display 456 can include the QWERTY keypad as discussed herein. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 214 shown in FIG. 2, and supported electronics such as the processor and memory of FIG. 4A. In one embodiment, these devices will be Internet enabled and include GPS and map capabilities and functions.

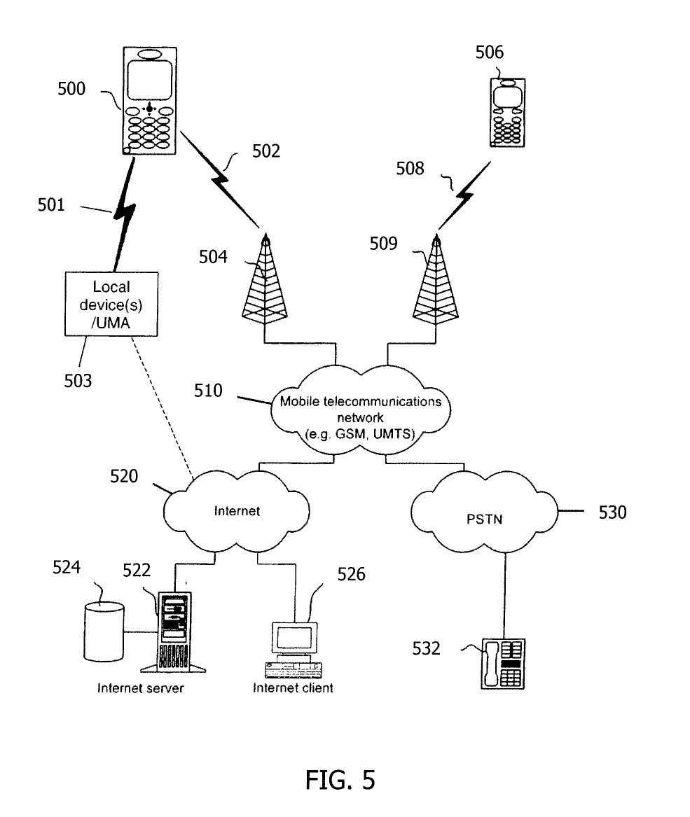

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the process modules 222 of FIG. 2 includes communication module 234 that is configured to interact with, and communicate with, the system described with respect to FIG. 5.

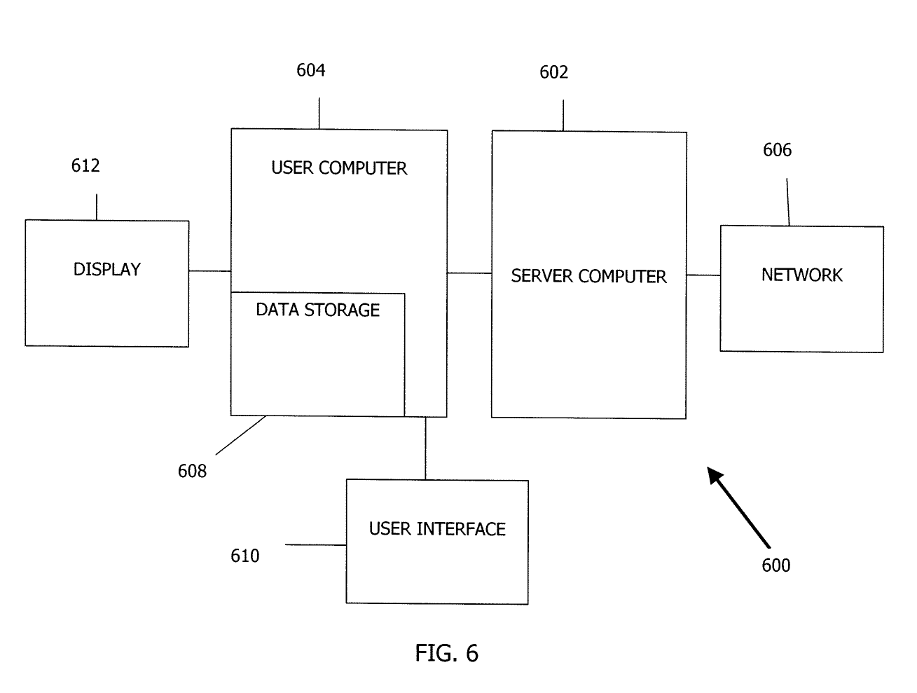

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practice aspects of the invention. The apparatus 600 can include computer readable program code means stored on a computer readable storage medium for carrying out and executing the process steps described herein. In one embodiment the computer readable program code is stored in a memory of the device. In alternate embodiments the computer readable program code can be stored in memory or memory medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is adapted to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for directly entering both numeric and alphabetic characters from an idle state of a mobile device without the need to manually change a character input mode of the device. When the default mode of a device, in a idle state, is a numeric character input, inputted characters will be presented as numeric characters until an input of a non-numeric character is detected. When the entry of a non-numeric character is detected, the character input mode of the device is changed to the alphabetic character input mode, and all the previously entered characters are converted to the corresponding alphabetic character, based on the letter-number keyboard overlay. Predictive text solutions can provide suggestions for words based on the character string input. When the character input mode is numeric, words corresponding to the sequence of numeric inputs will be presented as alternative selections. When a sequence of character inputs does not include a non-numeric key input, activation of a pre-determined key or function can be used to convert the inputted character string into the corresponding alphabetical equivalent.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

1. A method comprising:
detecting a character input to a device and if the device is in an alphabetic character input mode, presenting a corresponding alphabetic character on a display of the device; and,
if the device is not in an alphabetic character input mode:
determining a type of the character input, and if the type of character input is a numeric character, presenting the numeric character on a display of the device;
if the type of the character input is an alphabetic character, presenting the alphabetic character on the display of the device, changing a state of the device to the alphabetic character input mode, and converting any prior character input of a character input string into corresponding alphabetic characters.

2. The method of claim 1 further comprising:
determining an alphabetic character corresponding to each numeric character input of the character input string, and presenting on the display of the device, at least one alphabetic word string alternative that comprises at least a partial sequence of characters of the character input string.

3. The method of claim 2 further comprising, updating the at least one alphabetic word string alternatives for each additional inputted character.

4. The method of claim 1 further comprising:
using a word recognition processor of the device to interpret the at least one word input string and if the at least one word input string corresponds to a function or application of the device, presenting at least one menu option on the display of the device related to the corresponding function.

5. The method of claim 1 further comprising if a number of words in the at least one word input string exceeds a maximum size of any address book entry of an address book application in the device, presenting at least one set of menu options on the display of the device corresponding to at least one text editing application.

6. The method of claim 5 wherein the at least one text editing application is an instant messaging application, a electronic mail application, a short message service application, a multimedia message application, a notes application, a calendar application, a status application or a document application.

7. The method of claim 1 wherein the alphabetic character corresponds to a non-numeric key of the device.

8. The method of claim 1 further comprising presenting, in a separate window of the display, an alphabetic character corresponding to each presented numeric character.

9. The method of claim 1 further comprising, after detecting an input of a numeric character string, activating a character convert function of the device to convert the numeric character string into a corresponding alphabetic character string.

10. An apparatus comprising:
at least one processor, the at least one processor configured to:
detect a character input to the input unit of the apparatus;
present a numeric character corresponding to the inputted character on a display unit to form a numerical character input string unless the character input is a non-numeric character input; and
present an alphabetic character corresponding to the detected character input on the display unit if the character input is a non-numeric character;
change a character input mode of the device to an alphabetic character input mode; and
convert any previously inputted numeric characters in the numerical character input string into corresponding alphabetic characters to form an alphabetic character string.

11. The apparatus of claim 10 wherein the at least one processor is further configured to identify and present at least one word in a word list on the display corresponding to an alphabetical equivalent of at least a portion of the numerical character input string or alphabetic character string.

12. The apparatus of claim 11 wherein the at least one processor is further configured to update the word list each time a character input is detected.

13. The apparatus of claim 10 wherein the at least one processor is further configured to convert the numerical character input string into the alphabetic character string when an activation of a character conversion function of the apparatus is detected.

14. The apparatus of claim 10 further comprising that the at least one processor is configured to present a corresponding alphabetic character for each numeric character in a separate window of the display.

15. The apparatus of claim 10 further comprising that the at least one processor is configured to determine that the alphabetic character string corresponds to at least one application, function or command of the apparatus, and present a menu of options on a display corresponding to the at least one application, function or command of the apparatus.

16. The apparatus of claim 10, wherein the apparatus comprises a mobile communication device.

17. A computer program product comprising a computer readable storage medium configured to execute the method according to claim 1 when implemented on a device including at least one processor.

18. A method comprising:
detecting, during an idle state of a mobile communication device, a character input on a keyboard of the device;
determining, in a processor of the device, if the character input is a non-numeric character, and if the character input is not a non-numeric character, presenting a corresponding character on a display of the device; and
if the character is a non-numeric character, presenting the non-numeric character on the display of the device, changing a character input mode of the device to an alphabetic character input mode, and converting any previously presented numeric characters into corresponding alphabetic characters.

19. The method of claim 18, further comprising after presenting the corresponding character or non-numeric character on the display of the device:
determining at least one word that corresponds at least partially to a character string form by each corresponding character or non-numeric character; and
presenting the at least one word in a list of words on the display of the device.

20. The method of claim 18 further comprising, after presenting the corresponding character on the display of the device, determining an alphabetic character corresponding to the presented corresponding character, and presenting the corresponding alphabetic character on the display.
